(19) United States
(12) Patent Application Publication
(10) Pub. No.: US 2018/0342927 A1
(43) Pub. Date: Nov. 29, 2018

(54) DRIVE APPARATUS

(71) Applicant: DENSO CORPORATION, Kariya-city (JP)

(72) Inventor: Shinichi OKADA, Toyohashi-city (JP)

(73) Assignee: DENSO CORPORATION, Kariya-city (JP)

(21) Appl. No.: 14/182,613

(22) Filed: Feb. 18, 2014

(30) Foreign Application Priority Data
Feb. 18, 2013 (JP) 2013-28930
Sep. 25, 2013 (JP) 2013-198315

(51) Int. Cl. H02K 7/116; H02K 7/112

(52) U.S. Cl. CPC H02K 7/116; H02K 7/112

(57) ABSTRACT

A drive apparatus includes an electric motor that has a stator, a rotor and a rotor shaft placed in an inside of a motor housing fixed to an axle. Rotation of the rotor shaft is transmitted to a hub, which is rotatable to the motor housing, through a first speed reducing device and a second speed reducing device. The first speed reducing device is placed on a radially inner side of coil ends of coils wound around the stator. In this way, the coil ends and the first speed reducing device are radially overlapped with each other by using a space located on a radially inner side of the coil ends of the motor.

### CROSS REFERENCE TO RELATED APPLICATION

This application is based on and incorporates herein by reference Japanese Patent Application No. 2013-28930 filed on Feb. 18, 2013 and Japanese Patent Application No. 2013-198315 filed on Sep. 25, 2013.

### TECHNICAL FIELD

The present disclosure relates to a drive apparatus.

### BACKGROUND

Previously, there is known a drive apparatus, which is installed to a wheel of an electric bicycle such that the drive apparatus assists a rider's pedal power or self-propels the electric bicycle.

In a drive apparatus recited in JP2000-53068A, an axle is fixed to front forks of an electric bicycle, and an electric motor is installed to the axle. In the motor, a rotor shaft is rotatable relative to a stator that is fixed to the axle. Rotation of a rotor shaft is transmitted to a hub through a first speed reducing device, a second speed reducing device and a one-way clutch. A wheel of the electric bicycle is rotated through rotation of the hub.

In the drive apparatus of JP2000-53068A, an outer diameter of the motor, an outer diameter of the first speed reducing device and an outer diameter of the second speed reducing device are substantially equal to each other. Since the first speed reducing device and the second speed reducing device are arranged one after another on one axial side of the motor, an axial size of the drive apparatus is disadvantageously increased.

### SUMMARY

The present disclosure is made in view of the above disadvantages.

According to the present disclosure, there is provided a drive apparatus, which includes a fixed shaft, a motor housing, an electric motor, a rotatable body, a first speed reducing device, and a second speed reducing device. The motor housing is fixed to the fixed shaft. The electric motor includes a stator, a rotor and a rotor shaft. The stator is fixed to the motor housing. The rotor is rotatable relative to the stator. The rotor shaft is rotatable integrally with the rotor. The rotatable body is configured into a tubular form and is rotatable relative to the motor housing. The first speed reducing device is placed on a radially inner side of a coil end of a coil, which is wound around the stator. The first speed reducing device reduces a rotational speed of rotation received from the rotor shaft and outputs the rotation of the reduced rotational speed. The second speed reducing device is placed on a side of the first speed reducing device, which is opposite from the electric motor. The second speed reducing device has an outer diameter, which is larger than an outer diameter of the first speed reducing device, and the second speed reducing device outputs the rotation of the reduced rotational speed received from the first speed reducing device to the rotatable body. The first speed reducing device includes a first sun gear, a first planetary gear and a first ring gear. The first sun gear receives the rotation of the rotor shaft. The first planetary gear is meshed with external teeth of the first sun gear and revolves around the first sun gear. The first ring gear is placed on an outer side of the first planetary gear and is fixed to the motor housing. The first ring gear is meshed with external teeth of the first planetary gear. The second speed reducing device includes a second sun gear, a second planetary gear and a second ring gear. The second sun gear is rotated through revolution of the first planetary gear. The second planetary gear is meshed with external teeth of the second sun gear and is rotatable about a rotational axis of the second planetary gear. The second ring gear is placed on an outer side of the second planetary gear and is rotated through rotation of the second planetary gear to transmit a drive force to the rotatable body located on a radially outer side of the second ring gear.

### BRIEF DESCRIPTION OF THE DRAWINGS

FIG. 1 is a cross-sectional view of a drive apparatus according to a first embodiment of the present disclosure;

FIG. 2 is a partial enlarged view of an area II in FIG. 1;

FIG. 3 is a cross-sectional view taken along line III-III in FIG. 2;

FIG. 4 is an exploded view of the drive apparatus according to the first embodiment of the present disclosure;

FIG. 5 is another exploded view of the drive apparatus according to the first embodiment of the present disclosure; and

FIG. 6 is a cross-sectional view of a drive apparatus according to a second embodiment of the present disclosure.

### DETAILED DESCRIPTION

Embodiments of the present disclosure will be described with reference to the accompanying drawings.

### First Embodiment

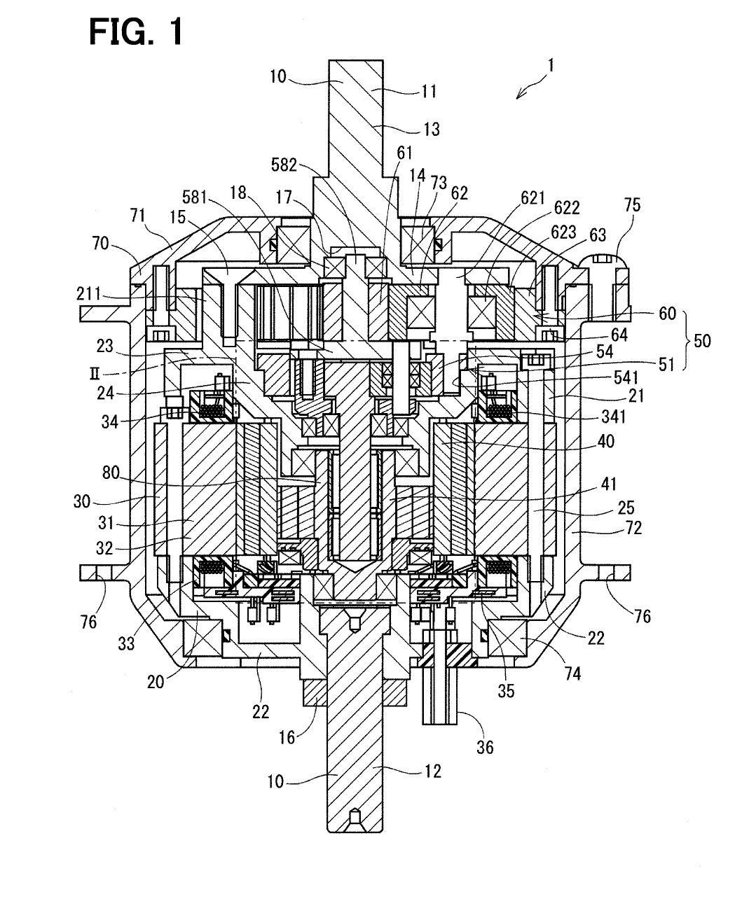

FIGS. 1 to 5 show a first embodiment of the present disclosure. In the present embodiment, a drive apparatus 1, which is used as a drive source of an electric bicycle, will be described. The drive apparatus 1 is installed to a wheel of the electric bicycle and outputs a drive force, which corresponds to a pedal force of a rider of the electric bicycle.

The drive apparatus 1 includes an axle 10 serving as a fixed shaft, a motor housing 20, an electric motor 30, a speed reducing device 50, a hub 70 serving as a rotatable body, and one-way clutches 80.

The axle 10 includes a first axle 11 and a second axle 12, which are coaxial with each other. The first axle 11 and the second axle 12 are fixed to a left front fork and a right front fork, respectively, of the electric bicycle. The first axle 11, which is depicted at an upper side of FIG. 1, includes a shaft 13 and a fixed plate 14. The fixed plate 14 radially outwardly extends from an end part of the shaft 13. The fixed plate 14 of the first axle 11 is fixed to the motor housing 20, which will be described later, with bolts 15. The second axle 12, which is depicted at a lower side of FIG. 1, is fixed to the motor housing 20 with a nut 16.

The motor housing 20 is made of, for example, aluminum. Furthermore, the motor housing 20 includes a first housing 21, which is configured into a cup form, and a second housing 22, which is configured into a dish form. A block 211 of the first housing 21, which axially projects from the first axle side end surface of the first housing 21, is fixed to the fixed plate 14 of the first axle 11 with the bolts 15. The first housing 21 includes a stator protecting portion 23 and a rotor protecting portion 24. The stator protecting portion 23 covers a stator 31 of the motor 30. The rotor protecting portion 24 is placed on a radially inner side of the stator protecting portion 23 and is axially recessed toward the rotor 40 side.

The second axle 12 is inserted into a hole, which is formed in a center portion of the second housing 22. The second housing 22 and the second axle 12 are fixed together with the nut 16.

The motor 30 is, for example, a brushless motor that is installed on an inner side of the motor housing 20. The motor 30 includes the stator 31, a rotor 40 and a rotor shaft 41.

The stator 31 includes an annular stator core 32, a dielectric body 33 and coils 34.

The stator core 32 is made of a magnetic material and is fixed to an inner side of the stator protecting portion 23 with through-bolts 25 at a location between the first housing 21 and the second housing 22.

The coils 34 are wound to slots (not shown) of the stator core 32 through the dielectric body 33. Ends of the coils 34, which axially project from the stator core 32, are referred to as coil ends 341.

The coils 34 are connected relative to each other through bus bars 35, which are provided on the second axle side of the coil ends 341, to form a Y connection or a delta connection.

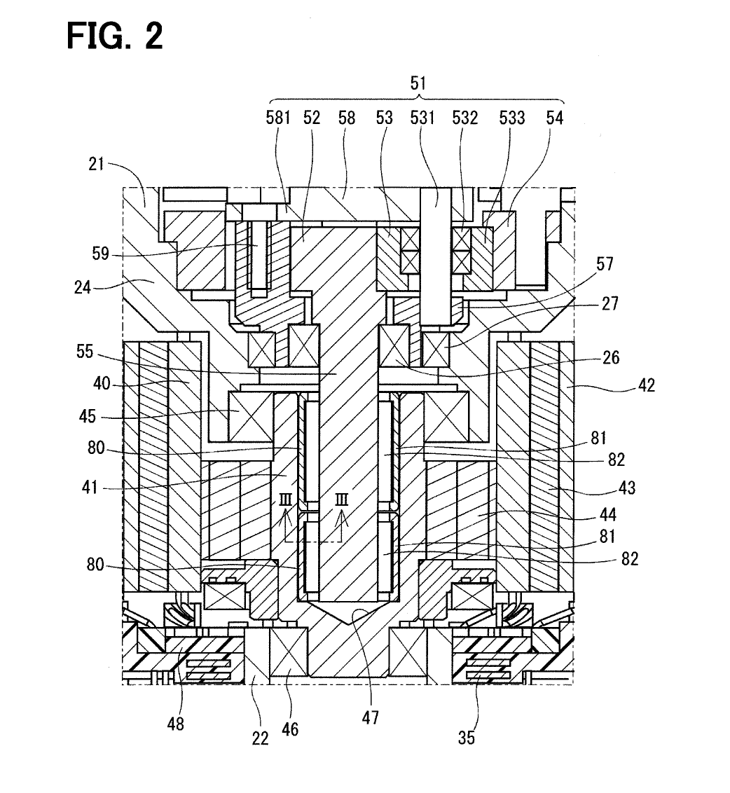

As shown in FIGS. 1 and 2, the rotor 40 is placed on a radially inner side of the stator 31 and is rotatable relative to the stator 31. The rotor 40 includes a rotor core 42, magnets 43, and a connecting portion 44. The rotor core 42 is made of a magnetic material and is formed to have an axial thickness that is the same as an axial thickness of the stator core 32. The magnets 43 are installed to holes formed in the rotor core 42. The magnets 43 form N-poles and S-poles, which are alternately arranged one after another in the rotational direction of the rotor core 42. The connecting portion 44 connects between the rotor core 42 and the rotor shaft 41. Therefore, the rotor shaft 41 is rotated integrally with the rotor 40.

One end part of the rotor shaft 41 is rotatably supported by the first housing 21 through a bearing 45, and the other end part of the rotor shaft 41 is rotatably supported by the second housing 22 through a bearing 46. The rotor shaft 41 has a receiving hole 47, which is axially recessed from the first axle side to the second axle side and receives the speed reducing device 50.

A magnetic sensor (not shown) is installed to a circuit board 48, which is configured into a circular disk form and is axially placed on the second axle side of the rotor 40. A rotational position of the rotor 40 is sensed with this magnetic sensor. When the coils 34 are supplied with an electric current from a harness 36, which is installed to the second housing 22, through the bus bars 35 according the rotational position of the rotor 40, the stator core 32 generates a rotating magnetic field. In this way, the rotor 40 and the rotor shaft 41 are rotated relative to the stator 31.

The two one-way clutches 80 are installed in an inside of the receiving hole 47 of the rotor shaft 41. One side of each one-way clutch 80 is connected to the rotor shaft 41, and another side of the one-way clutch 80 is connected to an input shaft 55 of a first speed reducing device 51, which will be described later. That is, the rotor shaft 41, the one-way clutches 80 and the input shaft 55 radially overlap with each other. In other words, the rotor shaft 41, a corresponding one of the one-way clutches 80 and the input shaft 55 are arranged one after another in a radial direction.

Each one-way clutch 80 is formed as, for example, a needle clutch. These two one-way clutches 80 are axially arranged one after another in series.

Each one-way clutch 80 includes an outer race 81 and rollers 82. The outer race 81 is securely press fitted to an inner wall of the receiving hole 47 of the rotor shaft 41. The input shaft 55 of the first speed reducing device 51 is inserted into an inside of the outer race 81 at a location, which is on a radially inner side of the rollers 82.

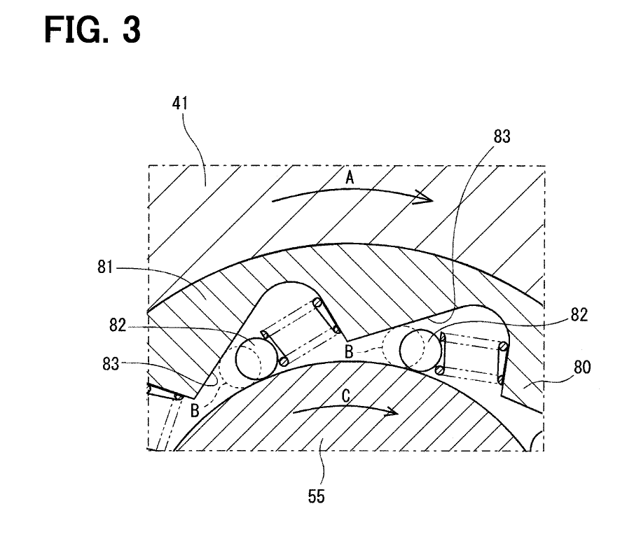

As shown in FIG. 3, when the rotor shaft 41 and the outer race 81 are rotated in a direction of an arrow A in FIG. 3, each roller 82 is moved to a corresponding location, which is indicated by a dotted line B in FIG. 3. Thereby, each roller 82 couples between a corresponding sloped surface 83 of the outer race 81 and the input shaft 55. In this way, the rotation of the rotor shaft 41 is transmitted to the input shaft 55.

In contrast, when the input shaft 55 is rotated in a direction of an arrow C in FIG. 3, each roller 82 is placed in a state indicated with a solid line in FIG. 3. Thereby, the coupling between the sloped surface 83 of the outer race 81 and the input shaft 55 is released. In this way, the conduction of the rotation of the input shaft 55 to the rotor shaft 41 is blocked.

Here, it should be noted that the structure shown in FIG. 3 is one example of the one-way clutch 80.

As shown in FIGS. 1 and 2, the speed reducing device 50 is placed between the first housing 21 and the first axle 11. The speed reducing device 50 includes a first speed reducing device 51 and a second speed reducing device 60.

The first speed reducing device 51 is placed in the inside of the rotor protecting portion 24 of the housing 21, which is configured into a recess. The rotor protecting portion 24 is placed on a radially inner side of the coil ends 341 of the stator 31. Specifically, the first speed reducing device 51 is placed on the radially inner side of the coil ends 341 of the stator 31 such that the rotor protecting portion 24 is radially placed between the coil ends 341 and the first speed reducing device 51.

The first speed reducing device 51 is, for example, a planetary gear speed reducing device and includes a first sun gear 52, first planetary gears 53 and a first ring gear 54. In the first speed reducing device 51, the first sun gear 52 forms an input side, and the first planetary gears 53 form an output-side. Furthermore, the first ring gear 54 forms a fixed side.

The first sun gear 52 is fixed to the input shaft 55, which receives the rotation of the rotor shaft 41 of the first housing 21. Alternatively, the first sun gear 52 may be formed integrally with the input shaft 55.

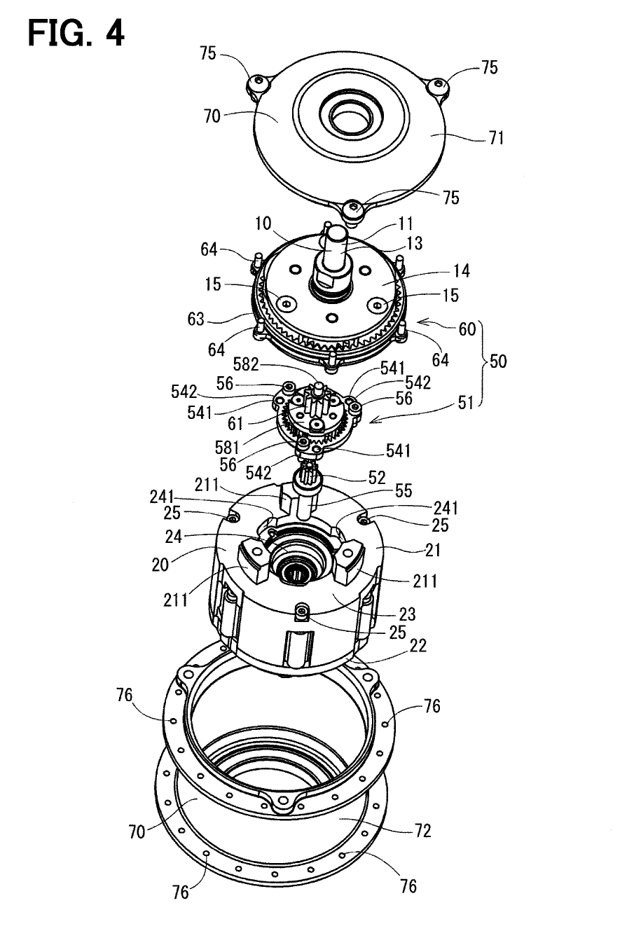

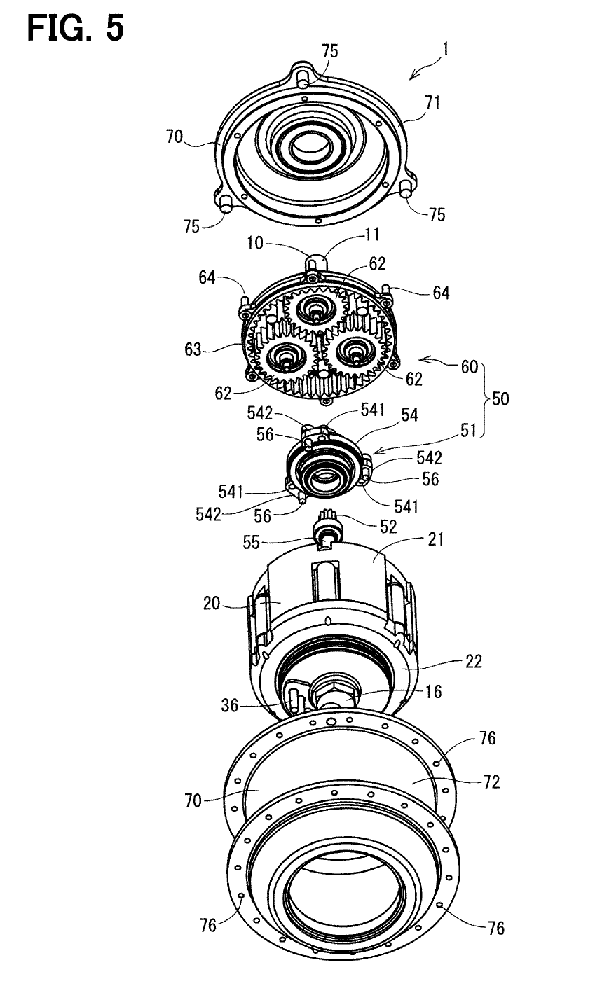

In the first ring gear 54, protrusions 542, each of which radially outwardly protrudes, are fitted into grooves 241, respectively, which are formed in the rotor protecting portion 24, and the protrusions 542 are fixed to a radially inner side part of the rotor protecting portion 24 with screws 56 (see FIGS. 4 and 5).

The number of the first planetary gears 53 is, for example, three, and these three first planetary gears 53 are placed on a radially inner side of the first ring gear 54. As shown in FIG. 2, each first planetary gear 53 includes a shaft member 531, a bearing 532, and external teeth 533. The external teeth 533 are arranged in a ring form and are connected to the shaft member 531 through the bearing 532.

The external teeth 533 of the first planetary gear 53 are meshed with external teeth of the first sun gear 52 and are also meshed with internal teeth of the first ring gear 54.

A second axle side end part of the shaft member 531 of each first planetary gear 53 is fixed to a lower support member 57, and a first axle side end part of the shaft member 531 is fixed to an upper support member 58.

The lower support member 57 is connected to the input shaft 55 through a bearing 26 and is connected to the first housing 21 through a bearing 27.

As shown in FIG. 1, the upper support member 58 includes a rotatable plate 581 and a second input shaft 582. An end part of the shaft member 531 of each first planetary gear 53 is fixed to the rotatable plate 581. The second input shaft 582 extends from the rotatable plate 581 toward the first axle side. The second input shaft 582 is connected to an inner side part of a recess 17 of the first axle 11 through a bearing 18.

The lower support member 57 and the upper support member 58 are connected with each other through the shaft members 531 of the first planetary gears 53 and a screw 59.

When the first sun gear 52, which is fixed to the input shaft 55, is rotated, each first planetary gear 53 rotates about its axis and revolves around the first sun gear 52. The revolution of each planetary gear 53 is implemented as a result of a reduction in the rotational speed of the rotation of the input shaft 55 and is outputted from the second input shaft 582 of the upper support member 58 to the second speed reducing device 60.

The second speed reducing device 60 is placed on a side of the first speed reducing device 51, which is axially opposite from the motor 30. Furthermore, the first axle 11 is placed on a side of the second speed reducing device 60, which is axially opposite from the motor 30, and the second axle 12 is placed on a side of the motor 30, which is axially opposite from the second speed reducing device 60. An outer diameter of the second speed reducing device 60 is larger than an outer diameter of the first speed reducing device 51.

The second speed reducing device 60 is, for example, a planetary gear speed reducing device and includes a second sun gear 61, second planetary gears 62 and a second ring gear 63. In the second speed reducing device 60, the second sun gear 61 forms an input side, and the second planetary gears 62 form a fixed side. Furthermore, the second ring gear 63 forms an output side.

The second sun gear 61 is fixed to the second input shaft 582, which receives the rotation of the first speed reducing device 51. Alternatively, the second sun gear 61 is formed integrally with the second input shaft 582.

The second ring gear 63 is fixed to a radially inner part of a hub 70, which will be described later, with screws 64.

The number of the second planetary gears 62 is, for example, three, and these three second planetary gears 62 are placed on a radially inner side of the second ring gear 63. Each second planetary gear 62 includes a shaft member 621, a bearing 622, and external teeth 623. The external teeth 623 are arranged in a ring form and are connected to the shaft member 621 through the bearing 622.

The external teeth 623 of the second planetary gear 62 are meshed with external teeth of the second sun gear 61 and are also meshed with internal teeth of the second ring gear 63.

A second axle side end part of the shaft member 621 of each second planetary gear 62 is fixed to a corresponding hole 541 of a lower support member 57, and a first axle side end part of the shaft member 621 is fixed to the fixed plate 14 of the first axle 11. In a case where the rigidity of the rotor protecting portion 24 is high, the second axle side end part of the shaft member 621 of the second planetary gear 62 may be fixed to the rotor protecting portion 24.

When the second sun gear 61, which is fixed to the second input shaft 582, is rotated, each second planetary gear 62 rotates about its axis to rotate the second ring gear 63. The rotation of the second ring gear 63 is implemented as a result of a reduction in the rotational speed of the rotation of the second input shaft 582. The rotational drive force of the second ring gear 63 is outputted to the hub 70 located on a radially outer side of the second ring gear 63.

The hub 70 is configured into a tubular form and is placed on an outer side of the motor housing 20 and the speed reducing device 50 such that the hub 70 is rotatable relative to the motor housing 20 and the speed reducing device 50.

The hub 70 includes a first hub 71, which is configured into a dish form, and a second hub 72, which is configured into a tubular form. The first hub 71, which is depicted at the upper side of FIG. 1, is connected to the first axle 11 through a bearing 73. The second hub 72, which is depicted at the lower side of FIG. 1, is connected to the second housing 22 through a bearing 74. The first hub 71 and the second hub 72 are fixed together with bolts 75. Therefore, when the rotation of the second speed reducing device 60 is outputted from the second ring gear 63 to the first hub 71, the first hub 71 and the second hub 72 are rotated together.

Spokes of the electric bicycle (not shown) can be connected to holes 76 formed in a flange of the hub 70. The spokes of the electric bicycle are connected to a tire through a rim. In this way, the rotation of the motor 30 is transmitted to the wheel of the electric bicycle through the one-way clutches 80, the speed reducing device 50 and the hub 70 to rotate the wheel of the electric bicycle.

However, the rotation of the wheel of the electric bicycle at the time of moving the electric bicycle in the forward direction is blocked by the one-way clutches 80 and is not transmitted to the motor 30.

Now, the advantages of the present embodiment will be described.

(1) In the present embodiment, the first speed reducing device 51 is placed on the radially inner side of the coil ends 341 of the motor 30.

In this way, the coil ends 341 radially overlap with the first speed reducing device 51. In other words, an axial extent of the first speed reducing device 51 overlaps with an axial extent of the coil ends 341. Therefore, the axial size of the drive apparatus 1 can be reduced.

Furthermore, the axial size of the stator core 32 and the axial size of the rotor core 42 are not changed in the motor 30. Therefore, the axial size of the drive apparatus 1 can be reduced while the output torque of the motor 30 is not influenced by the radial overlapping of the motor 30 and the first speed reducing device 51.

Furthermore, due to the provision of the multiple speed reducing devices, a speed reducing ratio can be increased. Therefore, the output torque of the motor 30 can be reduced, and the size of the motor 30 can be reduced.

(2) According to the present embodiment, in the second speed reducing device 60, each second planetary gear 62, which is meshed with the external teeth of the second sun gear 61, rotates about its rotational axis, and the second ring gear 63, which is meshed with the external teeth of the second planetary gears 62, transmits the drive force to the hub 70, which is located on the radially outer side of the second ring gear 63. In this way, the axial size of the second speed reducing device 60 can be reduced. Thus, the axial size of the drive apparatus 1 can be reduced.

(3) In the present embodiment, the outer diameter of the first speed reducing device 51 is smaller than the outer diameter of the second speed reducing device 60.

The rotation of the rotor shaft 41 is inputted to the first speed reducing device 51, and the rotation of the first speed reducing device 51 is inputted to the second speed reducing device 60. Therefore, the torque, which is applied to the first speed reducing device 51, is smaller than the torque, which is applied to the second speed reducing device 60. Thus, the axial size of the drive apparatus 1 can be reduced by reducing the outer diameter of the first speed reducing device 51 and placing the first speed reducing device 51 on the radially inner side of the coil end 341 of the motor 30.

(4) In the present embodiment, the motor housing 20 includes the stator protecting portion 23, and the rotor protecting portion 24. The rotor protecting portion 24 is located on the radially inner side of the stator protecting portion 23 and is recessed on the rotor side to receive the first speed reducing device 51.

When the motor housing 20 is interposed between the first speed reducing device 51 and the motor 30, it is possible to limit the intrusion of foreign objects into the inside of the motor 30 from the first speed reducing device side.

(5) In the present embodiment, the one end part the shaft member 621 of each second planetary gear 62 is fixed to the fixed plate 14 of the first axle 11, and the other end part of the shaft member 621 is fixed to the first ring gear 54 or the rotor protecting portion 24 of the motor housing 20.

In this way, it is not required to additionally provide a member for fixing the shaft member 621 of the second planetary gear 62 at a location between the first speed reducing device 51 and the second speed reducing device 60. Thus, the axial size of the drive apparatus 1 can be reduced.

(6) In the present embodiment, the drive apparatus 1 includes the one-way clutches 80 between the input shaft 55 and the rotor shaft 41.

In this way, in comparison to a comparative case where the one-way clutches 80 are placed between the second speed reducing device 60 and the hub 70, a torque, which is applied to the one-way clutches 80, becomes small. Thus, the size of the one-way clutches 80 can be reduced, and the size of the drive apparatus 1 can be reduced.

(7) In the present embodiment, the planetary gear speed reducing mechanism is used in each of the first speed reducing device 51 and the second speed reducing device 60. Thereby, the rotatable shaft of the speed reducing device is not wobbled, so that the vibrations of the drive apparatus 1 can be reduced.

### Second Embodiment

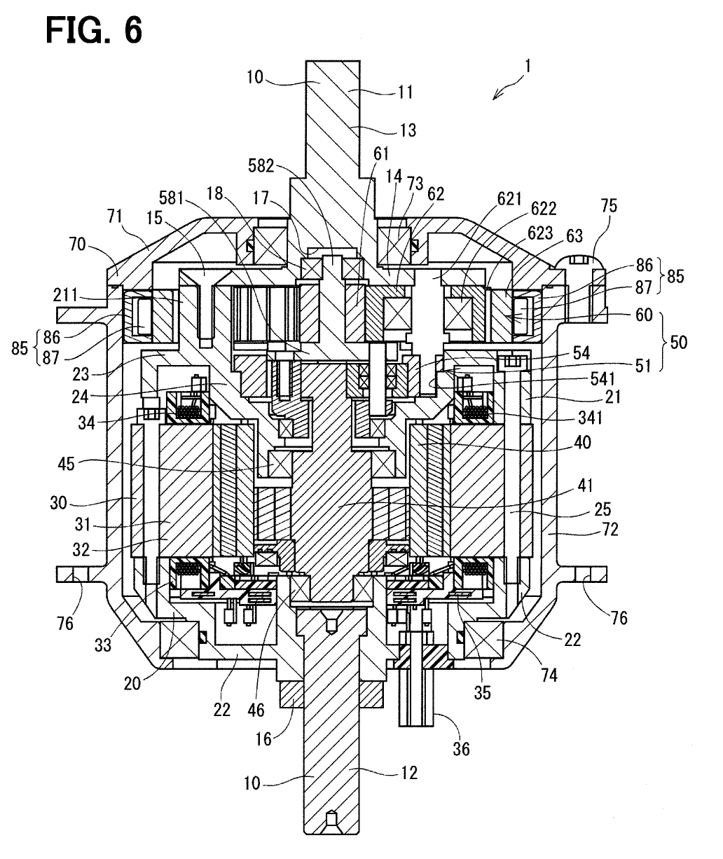

FIG. 6 shows a second embodiment of the present disclosure. In the second embodiment, components, which are similar to those discussed in the first embodiment, will be indicated by the same reference numerals and will not be discussed further.

In the second embodiment, the drive apparatus 1 does not include the one-way clutches 80 in the inside of the rotor shaft 41. The rotor shaft 41 serves as an input shaft of the first speed reducing device 51. The rotor shaft 41 is formed integrally with the first sun gear 52 or is fixed to the first sun gear 52.

In the second embodiment, the drive apparatus 1 includes a second one-way clutch 85 at a location between the second hub 72, which serves as the rotatable body, and the second ring gear 63 of the second speed reducing device 60.

The second one-way clutch 85 includes an outer race 86 and rollers 87. The outer race 86 of the second one-way clutch 85 is securely press fitted to the inner wall of the second hub 72. A radially outer wall of the second ring gear 63 is inserted at a location, which is on an inner side of the rollers 87 of the second one-way clutch 85 in the radial direction. The present embodiment shows one example of the second one-way clutch 85.

The drive force of the motor 30 is transmitted to the wheel of the electric bicycle to rotate the same through the first speed reducing device 51, the second speed reducing device 60, the second one-way clutch 85 and the hub 70.

At the time of moving the electric bicycle in the forward direction, the rotation of the wheel of the electric bicycle is blocked by the second one-way clutch and is not transmitted to the first speed reducing device 51, the second speed reducing device 60 and the motor 30.

Now, the advantages of the second embodiment will be described.

(1) In the second embodiment, the second one-way clutch 85 is placed between the second ring gear 63 of the second speed reducing device 60 and the second hub 72.

In this way, in comparison to the one-way clutches 80 of the first embodiment, the rotational speed of the second one-way clutch 85 is reduced. Thus, it is possible to reduce, for example, wearing of the rollers 87 of the second one-way clutch 85. Thereby, the reliability of the one-way clutch 85 with respect to the aging can be improved.

(2) In the second embodiment, the rotation of the wheel at the time of moving the electric bicycle in the forward direction is blocked by the second one-way clutch 85 and is not transmitted to the first speed reducing device 51, the second speed reducing device 60 and the motor 30. Therefore, at the time of moving the electric bicycle in the forward direction, it is possible to reduce the energy loss caused by, for example, the slide resistance of the first speed reducing device 51, the second speed reducing device 60 and the motor 30.

Furthermore, even in a case where the gear(s) of the first speed reducing device 51 or of the second speed reducing device 60 is locked, the hub 70 can be rotated by the second one-way clutch 85. Therefore, the rider of the electric bicycle can rotate the wheel through pedaling of the pedals of the electric bicycle.

### Other Embodiments

In the above-described embodiment, the drive apparatus, which is used as the drive source of the electric bicycle, is described. Alternately, in another embodiment, the drive apparatus may be used as various other types of drive sources.

In the above embodiment, the drive apparatus, which uses the brushless motor, is described. Alternately, in another embodiment, the motor, which is used in the drive apparatus, may be another type of electric motor, such as a brush motor.

In the above embodiment, the drive apparatus, which uses the planetary gear speed reducing device, is described. Alternately, in another embodiment, the speed reducing device, which is used in the drive apparatus, may be another type of speed reducing device, such as a cycloid speed reducing device.

In the above embodiment, the drive apparatus, which uses the needle one-way clutch, is described. Alternately, in another embodiment, the one-way clutch, which is used in the drive apparatus, may be any other type of one-way clutch. For example, the above-described one-way clutch may be modified with respect to the configuration or the number of the outer race or the rollers or may be modified to use a cam clutch.

Further alternately, in another embodiment, the one-way clutches may be eliminated. In such a case, the rotor shaft and the input shaft are integrally formed. In this way, it is possible to implement the regenerative charging function in the motor.

As discussed above, the present disclosure is not limited to the above embodiment and may be implemented in any other various ways within a scope of the present disclosure.

What is claimed is:

1. A drive apparatus comprising:
a fixed shaft;
a motor housing that is fixed to the fixed shaft;
an electric motor that includes:
a stator, which is fixed to the motor housing;
a rotor, which is rotatable relative to the stator; and
a rotor shaft, which is rotatable integrally with the rotor;
a rotatable body that is configured into a tubular form and is rotatable relative to the motor housing;
a first speed reducing device that is placed on a radially inner side of a coil end of a coil, which is wound around the stator, wherein the first speed reducing device reduces a rotational speed of rotation received from the rotor shaft and outputs the rotation of the reduced rotational speed; and
a second speed reducing device that is placed on a side of the first speed reducing device, which is opposite from the electric motor, wherein the second speed reducing device has an outer diameter, which is larger than an outer diameter of the first speed reducing device, and the second speed reducing device outputs the rotation of the reduced rotational speed received from the first speed reducing device to the rotatable body, wherein:
the first speed reducing device includes:
a first sun gear, which receives the rotation of the rotor shaft;
a first planetary gear, which is meshed with external teeth of the first sun gear and revolves around the first sun gear; and
a first ring gear, which is placed on an outer side of the first planetary gear and is fixed to the motor housing, wherein the first ring gear is meshed with external teeth of the first planetary gear; and
the second speed reducing device includes:
a second sun gear, which is rotated through revolution of the first planetary gear;
a second planetary gear, which is meshed with external teeth of the second sun gear and is rotatable about a rotational axis of the second planetary gear; and
a second ring gear, which is placed on an outer side of the second planetary gear and is rotated through rotation of the second planetary gear to transmit a drive force to the rotatable body located on a radially outer side of the second ring gear.

2. The drive apparatus according to claim 1, wherein the motor housing includes:
a stator protecting portion that covers the stator and the coil end; and
a rotor protecting portion that is placed on a radially inner side of the stator protecting portion and is axially recessed toward the rotor to receive the first speed reducing device.

3. The drive apparatus according to claim 1, wherein:
the fixed shaft includes:
a first axle that is placed on a side of the second speed reducing device, which is axially opposite from the electric motor; and
a second axle that is placed on a side of the electric motor, which is axially opposite from the second speed reducing device; and
a shaft member of the second planetary gear, which forms the rotational axis of the second planetary gear, has one end part fixed to the first axle and another end part fixed to the first ring gear or the rotor protecting portion of the motor housing.

4. The drive apparatus according to claim 1, comprising a one-way clutch located between an input shaft, which extends from the first sun gear, and the rotor shaft.

5. The drive apparatus according to claim 1, comprising a second one-way clutch located between the second ring gear of the second speed reducing device and the rotatable body.
